(19) United States
(12) Patent Application Publication
(10) Pub. No.: US 2018/0135399 A1
(43) Pub. Date: May 17, 2018

(54) A METHOD FOR TREATING WELLS WITH A PLURALITY OF PERFORATED INTERVALS (VARIANTS)

(71) Applicant: SCHLUMBERGER TECHNOLOGY CORPORATION, Sugar Land, TX (US)

(72) Inventors: Sergey Vladimirovich SEMENOV, Kurgan (RU); Chad KRAEMER, Katy, TX (US); Mohan Kanaka Raju PANGA, Sugar Land, TX (US); Maxim Pavlovich YUTKIN, Novosibirsk (RU); Ksenia Mikhailovna KAPRIELOVA, Novosibirsk (RU); Sergey Sergeevich SKIBA, Novosibirsk (RU); Bernhard Rudolf LUNGWITZ, Würzburg (RU); Denis Viktorovich BANNIKOV, Novosibirsk (RU)

(21) Appl. No.: 15/563,965

(22) PCT Filed: Apr. 3, 2015
(86) PCT No.: PCT/RU2015/000210

§ 371 Date: Oct. 3, 2017

(51) Int. Cl. E21B 43/267; C09K 8/92; C09K 8/80

(52) U.S. Cl. CPC E21B 43/267; C09K 8/80; C09K 8/92

(57) ABSTRACT

According to the claimed method, fracturing fluid is injected into a well containing a plurality of perforated intervals to create, and facilitate the propagation of, a hydraulic fracture in at least one of the perforated intervals; then, the suspension containing insoluble degradable material, oppositely charged polyelectrolytes and/or their precursors is injected into the well; at the same time, a degradable viscous phase, non-miscible with fracturing fluid, is formed from the oppositely charged polyelectrolytes and/or their precursors; a degradable plug is formed in at least one of the perforated intervals, fracture, or wellbore; diversion of the fracturing fluid flow to the next perforated interval is provided with subsequent plug degradation in at least one of the perforated intervals, fracture, or wellbore within the required time.

According to another variant of the claimed method, the suspension containing insoluble degradable material, a charged surface active agent, and an oppositely charged polyelectrolyte and/or its precursor is injected into the well.

### BACKGROUND

The present disclosure relates to methods for stimulating the inflow of oil and/or gas from a wellbore with a plurality of perforated intervals and penetrating one or more hydrocarbon-producing zones within a subterranean formation and, more specifically, to create diversion of treatment fluid in one or more perforated intervals.

Hydraulic fracturing of a subterranean formation aimed at creating a high-conductive path (fracture) through a reservoir (hydrocarbon-bearing layer) to stimulate the inflow of hydrocarbons (oil and gas) to the wellbore comprises the injection of fracturing fluid (treating fluid) containing the particles of proppant (also called “propping agent”) into the formation which results in the creation of a pack inside the reservoir. Such a proppant pack penetrates the reservoir, and its permeability is much higher compared to the permeability of the reservoir itself.

For the production of hydrocarbons (for example, crude oil, natural gas, etc.), a wellbore can be drilled to penetrate one or more hydrocarbon-bearing zones or subterranean formations also known pay zones. In the present disclosure, the term “perforated interval” or “pay interval” means a wellbore section that has been prepared for production by creating flow path between a pay zone and the wellbore.

In the simplest case, no zonal isolation is required for a well with one perforated interval in which treatment can be performed through all perforations at once. However, the development of unconventional hydrocarbon plays, such as shale gas or shale oil, generally requires long horizontal wells, splitted into many perforated intervals, and multi-stage hydraulic fracturing. Shale reservoirs can exhibit substantial pressure and stress anisotropy even inside one perforated interval. In such cases, the successful stimulation of a formation often requires the sequential treatment of perforated intervals. One of the key reasons necessitating efficient zonal isolation is the fact that treating fluids primarily enter high-permeability zones, as a result of which low-permeability zones remain unstimulated. This calls for the accurate and efficient isolation of the zone already treated by hydraulic fracturing from other zones to be stimulated next.

Zonal isolation is achieved through the use of diversion techniques. Conventional means for flow deflection/redirection/diversion are mechanical tools.

As a rule, mechanical tools for flow diversion are used in wells with casing and comprising using ball sealers or bridge plugs. Ball sealers for perforations, the most commercially available ones, are fully made of solid (non-degradable) materials or have solid (non-degradable) rigid shells that remain stable under high pressures and temperatures. However, ball sealers must be removed from plugged perforations at the stage of transition to oil-and-gas fluid production. Generally, non-degradable material removal operations are expensive and time-consuming.

Therefore, methods have appeared in the oil-and-gas industry for plugging holes with the use of degradable/decomposable materials to form a temporary/reversible isolation/plug, which loses isolating properties over time and does not prevent the production of hydrocarbons through a hydraulic fracture after the completion of well treatment operations.

The following known solutions (U.S. Pat. No. 7,565,929 B2, U.S. Pat. No. 8,167,043 B2, US20120285692 A1) describe multi-stage hydraulic fracturing methods using degradable material for isolating perforated clusters.

Patent application US20120285695 A1 describes a solution using a mixture of degradable material particles bound with the help of soluble containers for improving the consolidation of these particles during the injection and isolation of zones. However, the placement of containers with solid particles into a small-diameter well is a technically demanding task.

Patent application US20120181034 A1 describes various degradable materials for different temperature ranges. Degradable polyethers (PLA, PGA) are the examples of possible flow diverters with delayed degradation. The strength of formed isolations/plugs in the proposed solutions based on the use of solid particles is low (plugs are broken by pressure drops in the well).

The analysis of prior art demonstrates the necessity for an advanced method for creating improved isolation between wellbore intervals to ensure the reliable, operationally simplified redirection/diversion of the flow during the treatment or re-treatment of oil and gas wells with a plurality of perforated intervals.

### SUMMARY

This description discloses a new approach to creating isolations/plugs being resistant to pressure drops, more adaptable to the shapes and textures of fractures and ensuring the controlled rate of degradation/decomposition.

In certain embodiments, the disclosure relates to the method for treating wells with a plurality of perforated intervals. According to the claimed method, fracturing fluid is injected into a well containing a plurality of perforated intervals to create, and facilitate the propagation of, a hydraulic fracture in at least one of the perforated intervals; then, a suspension containing insoluble degradable material, oppositely charged polyelectrolytes, and/or their precursors are injected into the well; as this takes place, a degradable viscous phase, non-miscible with fracturing fluid, is formed from the oppositely charged polyelectrolytes and/or their precursors; a degradable plug is formed in at least one of the perforated intervals, fracture, wellbore; diversion of the fracturing fluid flow to the next perforated interval is provided with subsequent plug degradation/decomposition in at least one of the perforated intervals, fracture, or wellbore within the required time.

In other embodiments, this disclosure relates to a method for treating wells with a plurality of perforated intervals, wherein at stage (b) a suspension containing insoluble degradable material, a charged surfactant, and oppositely charged polyelectrolyte and/or its precursor is injected into the well.

In certain embodiments, this disclosure relates to a method for treating wells with a plurality of perforated intervals, wherein the method is completed by stage (e)—namely, by the diversion of the fracturing fluid flow to the next perforated interval.

Other aspects of the disclosure will become apparent from the subsequent description and appended claims.

### DESCRIPTION OF EMBODIMENTS

For the better understanding of the present disclosure, below is provided a description of the following embodiments which cannot be treated as limiting or defining the scope of the disclosure.

This description discloses a method for providing the formation of a degradable (temporary) plug in at least one of the perforated intervals, fracture, or wellbore to divert the fracturing fluid flow in such a manner that a suspension containing insoluble degradable material and oppositely charged polyelectrolytes and/or their precursors is injected into the well. Interaction between the oppositely charged polyelectrolytes and/or their precursors results in the formation of polyelectrolyte complexes (PEC) or interaction products of oppositely charged polymers, which act as a binding (degradable viscous water-insoluble) phase, non-miscible with fracturing fluid. The formed viscous phase binds the particles and/or fibers of insoluble degradable material which, thus, results in the formation of a degradable (temporary) plug in at least one of the selected perforated intervals, fracture, or wellbore.

Thus, a new method for creating a viscous strong plug to divert the flow is the basic idea of the present disclosure. This can result in the absence of necessity for the use of supplemental equipment in addition to the equipment utilised for hydraulic fracturing. This is possible due to the formation of a degradable viscous (binding) phase intended for consolidation/binding/combination of a mixture of particles and/or fibers of insoluble degradable material.

In this disclosure, the terms “consolidation”, “binding,” and “combination” are used as equivalents.

In this disclosure, the terms “degradable” and “decomposable” are used as equivalents.

The term “degradable viscous phase” is understood as a phase comprising polyelectrolyte complexes (PEC) and/or interaction products of oppositely charged polymers and having sufficient viscosity to hold the solid particles of insoluble degradable material in the volume of polyelectrolyte complexes (PEC) and/or interaction products of oppositely charged polymers or on the surface of the former and/or latter ones within the required time (necessary for isolation).

The viscosity of the degradable (binding) phase is controlled by the concentrations of added polyelectrolytes and/or their precursors to adjust the permeability of a plugging degradable plug—namely, to ensure the lowered permeability of the plug for flow diversion which, in turn, facilitates the creation of a plug that is more resistant to pressure drops.

The formation of the degradable viscous (binding) phase also facilitates the creation of a plug that is more adaptable to the shapes and textures of fractures due to the preservation of semi-liquid consistency.

Knowing the downhole temperature and varying the concentration of the degradation agent, we can achieve the desirable degradation rate of a plug having a fixed composition (see Example 5). The term “degradation rate of a plug” is defined as the rate of weight loss of a plug having a fixed composition during a certain amount of time.

According to an embodiment of the disclosure, fibers and/or solid particles are selected as examples of insoluble degradable materials.

According to an embodiment of the disclosure, the solid particles of insoluble degradable material have a size from approximately 0.1 mm to approximately 7 mm and are present in the suspension (injected at stage (b)) in the concentration from approximately 1.2 g/L to approximately 1,200 g/L and, in most cases, from approximately 6 g/L to approximately 240 g/L. Increasing the concentration of the particles of, for example, polylactic acid (PLA) up to 1,200 g/L will result in the improved quality of the formed plug. The concentration of the particles of, for example, PLA above 1,200 g/L will show a similar tendency, however, the injection of such a high concentration, though possible, is extremely complicated in terms of the surface pumping equipment. The particles of small size (for example, rounded particles with a diameter less than 1 mm) can be injected using available pumping equipment capable of injecting a suspension consisting of small solid particles and fibers. Also, increasing the sizes of the particles of, for example, polylactic acid (PLA) up to 7 mm allows forming plugs in a slot wider than 4 mm. A further increase in the sizes of the particles of, for example, PLA will maintain the described tendency, however, their injection, though possible, will be extremely complicated in terms of the above-ground equipment.

According to an embodiment of the disclosure, the fibers of insoluble degradable material have a length from approximately 2 mm to approximately 8.0 mm and are present in the suspension (injected at stage (b)) in the concentration from approximately 1.2 g/L to approximately 24 g/L and, in most cases, from approximately 6 g/L to approximately 12 g/L. Sizes of fibers are selected based on the simplicity of mixing with other components and the possibility of injection using available pumping equipment capable of injecting a suspension consisting of small solid particles and fibers.

According to an embodiment of the disclosure, insoluble degradable material comprises, but is not limited to, a polymer selected from the group consisting of substituted and unsubstituted lactides, glycolides; polylactic acid; polyglycolic acid; copolymers of polylactic acid and polyglycolic acid; copolymers of lactic acid with other acids containing hydroxylic, carboxylic, or hydroxycarboxylic groups; copolymers of glycolic acid with other acids containing hydroxylic, carboxylic, or hydroxycarboxylic groups; derivatives or combinations thereof. Additionally, the examples of suitable insoluble degradable materials are disclosed in patent applications US20130048283 A1 and US20130056213 A1, incorporated herein by reference.

In some embodiments of the disclosure, the formed polyelectrolyte complex (PEC) is an interaction product of two oppositely charged polyelectrolytes and/or their precursors. For instance, at least one cationic polyelectrolyte interacts with at least one oppositely charged (anionic) polyelectrolyte and/or its precursor with the formation of a precipitate as a viscous binding degradable water-insoluble phase.

In some embodiments of the disclosure, the formed polyelectrolyte complex (PEC) is an interaction product of a charged surfactant and an oppositely charged polyelectrolyte and/or its precursor. For example, the formation of the polyelectrolyte complex (PEC) occurs owing to the attraction of charged groups on the surfactant to the oppositely charged groups on the polyelectrolyte and/or its precursor (charged polymer) resulting in the formation of a precipitate as a viscous binding degradable water-insoluble phase.

There is known use of polyelectrolytes (cationic and anionic) for binding small particles during wastewater treatment. In so doing, polyelectrolytes are used to destabilise a colloidal suspension (polluted and process waters) or to initiate flocculation (precipitation of colloidal particles bound with the polyelectrolyte). A large class of industrial flocculants belongs to the group of polyelectrolytes (ionic polymers). Hereinafter, the terms “polymer flocculant”, “polyelectrolyte,” and “ionic polymer” are used as alternate terms. At the same time, industrial flocculants (in the form of polyelectrolyte) efficiently bind only the particles of micron and submicron size to facilitate the filtration of particulates. Such flocculants are inefficient for binding such particles as proppants (with a size of the millimetre order).

In the capacity of initial substances for the formation of a polyelectrolyte complex (PEC), “polyelectrolyte precursors” are employed, i.e. neutral polymers converted into charged polyelectrolytes as a result of a chemical or physical reaction. Variants of obtaining a polyelectrolyte complex (PEC) in a wellbore from a polyelectrolyte precursor (neutral polymer) are provided in patent application US20130048283 A1 incorporated herein by reference. The same application presents the examples of chemical reactions changing the charge of active groups of the polymeric precursor. The polyelectrolyte is formed from the polymeric precursor as a result of: hydrolysis of the polymer chemical groups, protonation of the polymer chemical groups, conversion of the chemical groups to salts, reaction of polymer amide groups with a reagent in the treatment fluid.

The possible selection of polyelectrolyte-surfactant (or other above-described combinations) to form a viscous degradable water-insoluble phase is dictated by the availability of opposite charges these components have in a water solution. For example, a cationic polyelectrolyte interacting with an anionic polyelectrolyte or surface active agent or its/their precursor forms viscous mass (agglomerate) capable of tightly holding the particles of plugging material (particles and fibers).

According to another embodiment, an anionic polyelectrolyte interacting with a cationic surface active agent (or a cationic polyelectrolyte interacting with an anionic surface active agent) forms viscous mass which is capable of holding the particles of plugging material (particles and fibers).

According to an embodiment of the disclosure, an anionic polymer(s) is/are selected from the group comprising carboxymethylated guar and cellulose, xanthan, carrageenan, lignosulfonate, polyacrylic acid, polyacrylamides, and precursors and derivatives thereof.

According to an embodiment of the disclosure, cationic polymer(s) is/are selected from the group comprising polyacrylamide copolymers such as diallyldimethylammonium chloride (DADMAC) and other quaternary ammonium monomers, polyvinyl pyrrolidone, polyethylenimine, chitosan, gelatin and other polypeptides, and precursors and derivatives thereof.

According to an embodiment of the disclosure, polyelectrolytes and/or their precursors are present in the suspension (injected at stage (b)) in the concentration from approximately 0.1 mL/L to approximately 50 mL/L and, in most cases, from approximately 0.2 mL/L to approximately 20 mL/L. The use of polyelectrolytes and/or their precursors in the concentration exceeding the described range is also possible but, in case of a lower concentration, the formed polyelectrolyte complex will not be capable of binding all particles and fibers, while in case of a higher concentration the concept will be unprofitable economically.

In most cases, in order to form a stable polyelectrolyte complex (PEC), cationic anionic polyelectrolytes are mixed in the ratio close to stoichiometric ratio (in terms of the number of charges) or in equal weight ratios.

Since the temperature range for the existence of a polyelectrolyte complex (PEC) as the basis of a plug for isolating perforations is sufficiently wide, the proposed method can help perform isolation operations at high downhole temperatures.

According to an embodiment of the disclosure, stage (c) of the formation of a degradable viscous phase implies the formation of polyelectrolytes from their precursors under the influence of variations in temperature, pH of the medium, chemical reaction between a precursor and another reagent, or combination thereof. The advantage of this variant of the formation of a degradable viscous phase (temporary viscous strong plug) consists in the fact that the formation of a degradable viscous phase will occur at the required point of time. It is desirable to have sufficiently liquid (easily transportable) material, which, upon delivery to the required location, will acquire the viscous properties of a polyelectrolyte complex necessary to plug holes. This is achieved by the conversion of an uncharged polymer to an ionic polymer (polyelectrolyte) as a result of the chemical or physical activation of active polymeric groups in downhole conditions.

According to an embodiment of the disclosure, the suspension (injected at stage (b)) additionally comprises non-degradable particles made of any material including ceramics, rubber, silicon dioxide, carbonates, sand, plastic, glass, and any proppant utilised in the hydraulic fracturing process, or combinations of these particles.

Combinations of inert and degradable substances may serve as a material for the preparation of plugging material particles. Example of the degradable substances include degradable polyethers (polylactic acid and polyglycolic acid ethers), wax, gelatin, hydrolysed polyvinyl acetate, polyvinyl alcohol, and other substances, solid and having the capability for slow degradation (on a scale of several hours or days depending on temperature) in downhole conditions.

According to an embodiment of the disclosure, the suspension (injected at stage (b)) additionally comprises an agent for the retardation or acceleration of plug degradation.

The required (necessary) time frame for plug existence is determined by the schedule of well operations and depends on the complexity and duration of each operation requiring the temporary isolation of other well zones. As practice shows, conducting multi-stage operations requires a time period from 24 hours to several days. Therefore, the time frame of plug existence can be adjusted using additives that accelerate or decelerate the degradation of plugging material particles. Examples of an accelerating agent include acid or alkaline medium that accelerates the degradation of polyethers or an oxidiser. Examples of a decelerating agent include any hydrophobic substance covering the surface of degrading particles, which hinders the contact of the particles with water. The composition of such additives is known from practical experience and obvious to an average specialist in well treatment.

According to an embodiment of the disclosure, the method comprises stages (a)-(e) successively repeated one or many times for diverting fracturing fluid from previous perforated intervals to at least one next perforated interval to create, and facilitate the propagation of, a hydraulic fracture, while plugs decompose subsequently at stage (f) due to the degradation of insoluble material within the required time.

In some embodiments of the disclosure, in order to reduce the concentrations of degradable material particles included in the PEC and to exclude particles greater than 1 mm, a certain sequence of loading the polyelectrolyte complex (PEC) and degradable material comprising the particles of different diameters and fibers is selected to form a viscous strong plug: first, the PEC comprising only two types of fibers, then the PEC comprising both fibers and particles of different size.

### EXAMPLES

### Example 1. Formation of a Plug from a Polyelectrolyte Complex and Degradable Material Comprising the Particles of Different Diameters and Fibers

The example demonstrates the formation of a viscous strong plug on the basis of a polyelectrolyte complex of polyelectrolyte-polyelectrolyte type and degradable material comprising the particles of different diameters and fibers.

As degradable material particles, polylactic acid particles (flakes of 0.3 mm in size and balls with the diameter of 1 mm and 2 mm) and two types of fibers from the same material (PLA) with the average length of 6 mm were selected. As initial materials for creating the polyelectrolyte complex, water-soluble polymers, an anionic copolymer of polyacrylamide (PAM), and cationic polyethylenimine in equal mass proportions were selected. The objective of the tests consisted in obtaining a plug with the lowest concentration of degradable material particles, which, at the same time, withstands the applied pressure differential in the experimental cell with a slot-like channel (simulating a hydraulic fracture entrance).

During the preparation of the polyelectrolyte complex, all components were mixed using an overhead mixer in the following order. Anionic polyelectrolyte (PAM) was added to 300 mL of tap water, then PLA fibers of one or two types and, after them, polymer particles (from PLA) of different sizes were added, the obtained suspension was stirred intensively; finally, cationic polyelectrolyte (PEE) was added. The obtained suspension was stirred until a viscous phase of polyelectrolyte complex (PEC) was formed. All fibers and particles were bound inside the viscous phase (PEC).

The obtained PEC was placed in a experimental cell having a open slot of 4 mm in width, after which constant differential pressure of 0.7 MPa (100 psi) was applied to the cell. After testing, the experimental cell was disassembled, and the formation of a slot-plugging plug was estimated visually.

The results of the experiments aimed at revealing the effect of the concentrations of the components used for PEC formation on the ability to form a plugging plug are presented in Table 1. Each experiment was conducted 2 or 3 times; the formation of a stable plug in all cases is marked as “plug,” the formation of the plug in some cases or partial plugging of the slot is marked as “partial success.” As can be seen from the presented results, the use of fibers and particles of several types ensures the reliable formation of a slot-plugging plug. The obtained plug remained stable under differential pressure up to 3.5 MPa (500 psi).

TABLE 1
Effect of the concentrations of the components used
for PEC formation on the ability to form a plug

| | | | First- | Second- | | | | Formation of a |
|---|---|---|---|---|---|---|---|---|
| | | | type | type | | | | plugging plug |
| | PAM | PAM, | fibers, | fibers, | PLA particles, g/L | | | (on a slot of 4 |
| Test | mL/L | mL/L | g/L | g/L | 2 mm | 1 mm | 0.3 mm | mm in width) |
| 1 | 7 | 7 | 6 | — | 60 | 60 | — | Partial success |
| 2 | 7 | 7 | 6 | — | 30 | 30 | — | Partial success |
| 3 | 7 | 7 | 12 | — | 30 | 30 | — | Partial success |
| 4 | 5 | 5 | 6 | — | 90 | 90 | — | Plug |
| 5 | 5 | 5 | 6 | — | 60 | 60 | — | Plug |
| 6 | 5 | 5 | 6 | — | 50 | 50 | — | Partial success |
| 7 | 5 | 5 | 9 | 1.8 | 90 | 30 | 90 | Plug |
| 8 | 5 | 5 | 6 | 3.6 | 200 | 0 | 90 | Plug |
| 9 | 5 | 5 | 3 | 5.4 | 30 | 30 | — | Plug |
| 10 | 5 | 5 | 3 | 5.4 | — | 60 | 60 | Plug |
| 11 | 5 | 5 | 3 | 5.4 | — | 30 | 30 | Partial success |

Obviously, plug formation at higher concentrations of degradable material (within the limits specified in the claims) will be even more successful. A further increase in the concentration of PLA particles up to 1,200 g/L will result in the improved quality of the formed plug. The concentration of PLA particles above 1,200 g/L will show a similar tendency, however, the injection of such a high concentration will be extremely complicated in terms of the surface pumping equipment.

Also, increasing sizes of PLA particles up to 7 mm allows forming plugs in a slot wider than 4 mm. A further increase in sizes of PLA particles will maintain the described tendency, however, their injection will be extremely complicated in terms of the surface pumping equipment.

### Example 2. Formation of a Plug from a Polyelectrolyte Complex and Degradable Material Comprising the Particles of Different Diameters and Fibers

The example demonstrates the formation of a viscous strong plug on the basis of a polyelectrolyte complex of polyelectrolyte-polyelectrolyte type and degradable material comprising the particles of different diameters and fibers.

In this example, the formation of the plug was conducted in the following order (sequence), in two stages. First, PEC comprising only 6-mm PLA fibers of two types, rigid and flexible, was loaded into the cell. Then, PEC comprising both PLA fibers and particles of different sizes was loaded into the cell. After this, the cell was disassembled, and the formation of a slot-plugging plug was estimated visually. Polyelectrolyte complexes for both stages were prepared similarly to the method described in Example 1.

The obtained results are shown in Table 2. It is evident from the table that using the above plug formation sequence ensures a considerable reduction in the concentration of PLA particles included in PEC and the exclusion of particles greater than 1 mm. The obtained result can be explained as follows. At the first stage, PEC comprising only fibers forms a weak permeable layer that plugs the slot. At the second stage, PEC comprising both fibers and particles forms a strong impermeable plug that plugs the slot. The obtained plug remained stable under differential pressure up to 3.5 MPa (500 psi).

TABLE 2
Effect of the concentrations of the components used for
PEC formation on the ability to form a plugging plug

| | | | | First- | First- | | | Formation of a |
|---|---|---|---|---|---|---|---|---|
| | | | | type | type | | | plugging plug |
| | | PAM, | PAM, | fibers, | fibers, | PLA particles, g/L | | (on a slot of 4 |
| Test | Stage | mL/L | mL/L | g/L | g/L | 1 mm | 0.3 mm | mm in width) |
| 1 | 1 | 1 | 1 | 6 | 6 | — | — | Plug |
| | 2 | 5 | 5 | 6 | 6 | 30 | 30 | |
| 2 | 1 | 1 | 1 | 4.8 | 4.8 | — | — | Plug |
| | 2 | 5 | 5 | 6 | 6 | 6 | 6 | |
| 3 | 1 | 1 | 1 | 4.8 | 4.8 | — | — | Plug |
| | 2 | 5 | 5 | 2.4 | 2.4 | 6 | 6 | |

### Example 3. Formation of a Plug from a Polyelectrolyte Complex and Degradable Material Comprising the Particles of Different Diameters and Fibers and Non-Degradable Particles

The example demonstrates the formation of a viscous strong plug on the basis of a polyelectrolyte complex of polyelectrolyte-polyelectrolyte type and degradable material (comprising the particles of different diameters and fibers) and non-degradable particles.

As degradable material particles, polylactic acid particles (flakes of 0.3 mm in size and balls with the diameter of 1 mm and 2 mm) and two types of fibers from the same material (PLA) with the average length of 6 mm were selected. As non-degradable particles, sand with particles of 0.15 mm in size was selected. As initial materials for creating the polyelectrolyte complex, water-soluble polymers, an anionic copolymer of polyacrylamide (PAM), and cationic polyethylenimine (PEI) in equal mass proportions were selected.

During the preparation of the polyelectrolyte complex, all components were mixed using an overhead mixer in the following order. Anionic polyelectrolyte (PAM) was added to 300 mL of tap water, then PLA fibers of one or two types and, after them, polymeric particles (from PLA) of different sizes were added; further, sand was added, and the obtained suspension was stirred intensively; finally, PEI was added. The obtained suspension was stirred until a viscous phase of polyelectrolyte complex (PEC) was formed. All fibers, particles of degradable material, and sand were bound inside the viscous phase of PEC.

To form PEC in this experiment, the composition shown in Table 1, experiment 10, was used. Sand was added in the concentration of 120 g/L. The obtained PEC was loaded into the cell and tested according to the procedure described in Example 1. The experiment resulted in the formation of a slot-plugging plug. The obtained plug remained stable under differential pressure up to 3.5 MPa (500 psi).

### Example 4. Formation of a Plug from a Polyelectrolyte Complex of Polyelectrolyte Surface Active Agent Type and Degradable Material Comprising the Particles of Different Diameters and Fibers

The example demonstrates the formation of a viscous strong plug on the basis of a polyelectrolyte complex of polyelectrolyte-surface active agent type and degradable material comprising the particles of different diameters and fibers.

As degradable material particles, polylactic acid particles (flakes of 0.3 mm in size and balls with the diameter of 1 mm and 2 mm) and two types of fibers from the same material (PLA) with the average length of 6 mm were selected. As initial materials for creating the polyelectrolyte complex, water-soluble polymers, an anionic copolymer of polyacrylamide (PAM), and a cationic surface active agent on the basis of quaternary ammonium salt were selected in equal mass proportions.

During the preparation of the polyelectrolyte complex, all components were mixed using an overhead mixer in the following order. Anionic polyelectrolyte (PAM) was added to 300 mL of tap water, then PLA fibers of one or two types and, after them, polymeric particles (from PLA) of different sizes were added, and the obtained suspension was stirred intensively; finally, a cationic surface active agent was added. The obtained suspension was stirred until a viscous phase of polyelectrolyte complex (PEC) was formed. All fibers and particles were bound inside the viscous phase of PEC.

To form PEC in this experiment, the composition shown in Table 1, Test 10, was used. A cationic surfactant was used instead of PEI. The obtained PEC was loaded into the cell and tested according to the procedure described in Example 1. The experiment resulted in the formation of a slot-plugging plug. The obtained plug remained stable under differential pressure up to 3.5 MPa (500 psi).

### Example 5. Degradation of a Formed Plug at Elevated Temperature

The example demonstrates the degradation of PEC utilised to form a plug at elevated temperature.

To form PEC in this experiment, the composition shown in Table 1, Test 10, was used. When mixing all components, a degradation-accelerating agent based on ammonium persulfate in the concentration of 0.6 g/L or 0.12 g/L was added to the suspension. The obtained PEC was placed in an oven and heated at 80° C. The degradation of the polyelectrolyte complex phase was estimated visually during the first several hours. The degradation of PLA particles and fibers was estimated by weight loss over time.

When the concentration of the degradation-accelerating agent was 0.6 g/L, the full degradation of the polyelectrolyte complex phase had been observed for 8 hours. When the concentration of the degradation-accelerating agent was 0.12 g/L, the full degradation of the polyelectrolyte complex phase had been observed for 4 hours. The degradation of PLA particles and PLA fibers in both cases had been 70% by weight for 3 weeks, which corresponds to the degradation rate of polylactic acid.

At higher temperature, the degradation of the polyelectrolyte complex phase and of PLA particles and fibers proceeds much faster. At lower temperature, the degradation of the polyelectrolyte complex phase and of PLA particles and fibers proceeds much slower.

This example demonstrates that, knowing the downhole temperature and varying the concentration of the degrading agent, we can achieve the desirable degradation rate of a plugging plug.

The above embodiments should not be treated as limiting the scope of the patent claims of the disclosure. It is apparent to any specialist in the art that there is a possibility to make a plurality of changes in the above embodiments without departing from the principles of the disclosure stated in the claims.

1. The method for treating wells with a plurality of perforated intervals comprises the following stages:
a) injection of fracturing fluid into a well with a plurality of perforated intervals to create, and facilitate the propagation of, a hydraulic fracture in at least one of the perforated intervals;
b) injection of a suspension containing insoluble degradable material and oppositely charged polyelectrolytes and/or their precursors into the well;
c) formation of the degradable viscous phase, non-miscible with fracturing fluid, from the oppositely charged polyelectrolytes and/or their precursors;
d) formation of a degradable plug in at least one of the perforated intervals, fracture, and wellbore;
e) diversion of the fracturing fluid flow to the next perforated interval; and
f) degradation of the plug in at least one of the perforated intervals, fracture, and wellbore within the required time.

2. The method of claim 1, wherein insoluble degradable material comprises fibers and/or particles.

3. The method of claim 2, wherein the particles of insoluble degradable material have a size from approximately 0.1 mm to approximately 7 mm and, in most cases, from approximately 0.1 mm to approximately 2 mm.

4. The method of claim 2, wherein the particles of insoluble degradable material are present in the said suspension in the concentration from approximately 1.2 g/L to approximately 1,200 g/L and, in most cases, from approximately 6 g/L to approximately 240 g/L.

5. The method of claim 2, wherein the fibers of insoluble degradable material have a length from approximately 2 mm to approximately 8 mm.

6. The method of claim 2, wherein the fibers of insoluble degradable material are present in the said suspension in the concentration from approximately 1.2 g/L to approximately 24 g/L and, in most cases, from approximately 6 g/L to approximately 12 g/L.

7. The method of claim 1, wherein insoluble degradable material comprises a polymer selected from the group consisting of substituted and unsubstituted lactides and glycolides; polylactic acid; polyglycolic acid; copolymers of polylactic acid and polyglycolic acid; copolymers of lactic acid with other acids containing hydroxylic, carboxylic, or hydroxycarboxylic groups; copolymers of glycolic acid with other acids containing hydroxylic, carboxylic, or hydroxycarboxylic groups; and derivatives or combinations thereof.

8. The method of claim 1, wherein oppositely charged polyelectrolytes are represented by at least one anionic polymer and at least one cationic polymer.

9. The method of claim 8, wherein anionic polymer(s) is/are selected from the group comprising carboxymethylated guar and cellulose, xanthan, carrageenan, lignosulfonate, polyacrylic acid, polyacrylamides, and precursors and derivatives thereof.

10. The method of claim 8, wherein cationic polymer(s) is/are selected from the group comprising polyacrylamide copolymers such as diallyldimethylammonium chloride (DADMAC) and other quaternary ammonium monomers, polyvinyl pyrrolidone, polyethylenimine, chitosan, gelatin and other polypeptides, and precursors and derivatives thereof.

11. The method of claim 1, wherein polyelectrolytes and/or their precursors are present in the said suspension in the concentration from approximately 0.1 mL/L to approximately 50 mL/L and, in most cases, from approximately 0.2 mL/L to approximately 20 mL/L.

12. The method of claim 1, wherein stage (c) of the formation of the degradable viscous phase implies the formation of polyelectrolytes from their precursors under the influence of variations in temperature, pH of the medium, chemical reaction between a precursor and another reagent, or combination thereof.

13. The method of claim 1, wherein the suspension additionally comprises non-degradable particles made of any material including ceramics, rubber, silicon dioxide, carbonates, sand, plastic, glass, and any proppant utilised in the hydraulic fracturing process, or combinations of these particles.

14. The method of claim 1, wherein the suspension additionally comprises an agent for the retardation or acceleration of plug degradation.

15. The method of claim 1, wherein the method comprises stages (a)-(e) successively repeated one or many times for diverting fracturing fluid from previous perforated intervals to at least one next perforated interval to create, and facilitate the propagation of, a hydraulic fracture, while plugs decompose subsequently at stage (f) due to the degradation of insoluble material.

16. A method for treating wells with a plurality of perforated intervals comprises the following stages:
a) injection of fracturing fluid into a well with a plurality of perforated intervals to create, and facilitate the propagation of, a hydraulic fracture in at least one of the perforated intervals;
b) injection of the suspension containing insoluble degradable material, a charged surface active agent, and an oppositely charged polyelectrolyte and/or its precursors into the well;
c) formation of the degradable viscous phase, non-miscible with fracturing fluid, from the oppositely charged polyelectrolytes and/or their precursors;
d) formation of a degradable plug in at least one of the perforated intervals, fracture, and wellbore;
e) diversion of the fracturing fluid flow to the next perforated interval.

17. The method of claim 16, wherein a charged surface active agent is represented by at least one anionic surface active agent or by at least one cationic surface active agent.

18. The method of claim 16, wherein an anionic or cationic surface active agent is present in the said suspension in the concentration from approximately 0.1 mL/L to approximately 50 mL/L and, in most cases, from approximately 0.2 mL/L to approximately 20 mL/L.

19. The method of claim 16 further comprising the degradation of a plug in at least one of the perforated intervals, fracture, or wellbore.

20. A method for treating wells with a plurality of perforated intervals comprises the following stages:
a) injection of fracturing fluid into a well with a plurality of perforated intervals to create, and facilitate the propagation of, a hydraulic fracture in at least one of the perforated intervals;
b) injection of the suspension containing insoluble degradable material and oppositely charged polyelectrolytes and/or their precursors into the well;
c) formation of a degradable viscous phase, non-miscible with fracturing fluid, from the oppositely charged polyelectrolytes and/or their precursors;
d) formation of a degradable plug in at least one of the perforated intervals, fracture, and wellbore;
e) diversion of the fracturing fluid flow to the next perforated interval.
